(19) United States
(12) Patent Application Publication
(10) Pub. No.: US 2007/0153021 A1
(43) Pub. Date: Jul. 5, 2007

(54) DATA CONVERTING CIRCUIT AND DISPLAY APPARATUS USING THE SAME

(75) Inventors: Kengo UMEDA, Kanagawa (JP); Yoshihiko Hori, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 11/620,285

(22) Filed: Jan. 5, 2007

(30) Foreign Application Priority Data
Jan. 5, 2006 (JP) 2006-000634

(51) Int. Cl. G09G 5/02

(52) U.S. Cl. 345/600

(57) ABSTRACT

In a data converting circuit, an approximation calculation circuit calculates an approximation value of an output to input data by using an n-th order equation (n is an integer equal to or more than one). An error reducing circuit generates an error correction value by using a multiplication factor determined based on the input data. An addition section adds the approximation value and the error correction value and outputs an addition result.

### BACKGROUND OF THE INVENTION

1. Field of the Invention

The present invention relates to a data converting circuit for converting an input video data and a display apparatus using the same.

2. Description of the Related Art

A video signal of a video image broadcasted in a usual television broadcast is subjected to γ correction to match the IT (current—brightness) characteristic of a cathode-ray tube and then compensation resultant signal is transmitted. Accordingly, when the video signal is displayed on a display apparatus other than the cathode-ray tube (CRT), a gradation correction (hereafter, referred to as γ correction) that matches the drive voltage—brightness characteristic of the display apparatus is required to be carried out. Through application of the γ correction, it becomes possible to reproduce the contrast of an original image accurately while matching the brightness level of the original image. Also, even in case of a color image, the hue of the original image can be faithfully reproduced by individually applying the γ correction on each of three primary colors. In addition, the setting of a color temperature and the adjustment of white balance can be achieved by adjusting the γ correction value.

FIG. 1C is a V-T characteristic graph showing the drive voltage—brightness characteristic of a liquid crystal panel. The drive voltage—brightness characteristic of the liquid crystal panel is non-linear as shown in FIG. 1C. For this reason, a digital video data inputted as a video signal needs to be corrected under assumption that it has a non-linear drive voltage waveform. A general liquid crystal display apparatus uses a non-linear DA converter (DAC) to convert the digital data into an analog voltage (drive voltage) signal corresponding to the drive voltage—brightness characteristic of the liquid crystal panel. However, in recent years, as shown in FIG. 1B, a liquid crystal display apparatus has been developed which uses a linear DAC (linear DA converter) for linearly converting a digital data into an analog voltage signal. In the liquid crystal display apparatus that uses the linear DAC (linear DA converter), a data converting circuit, such as LUT (Look Up Table), an approximation calculation circuit and the like, converts a digital video data, and the data after the conversion (hereinafter, to be referred to as “corrected digital video data”) is DA-converted to obtain a drive voltage signal matching with the V-T characteristic. The corrected digital video data exhibits a non-linear curve as shown in FIG. 1A, to allow the drive voltage signal corresponding to the V-T characteristic shown in FIG. 1C to be obtained. For this reason, the digital video data supplied to the data converting circuit needs to be converted into the corrected digital video data whose number of bits is large. For example, when the digital video data supplied to the data converting circuit has 10 bits, the corrected digital video data needs to have 12 bits.

Generally, a LUT (Look Up Table) is used in the data converting circuit. However, in recent years, the approximation calculation circuit has been used from the viewpoint of a circuit scale and flexibility. In the approximation calculation circuit, the digital video data is defined as a variable, and a linear approximation calculation or a polynomial approximation calculation is used to calculate the corrected digital video data, as shown in FIG. 1A. Although the circuit scale of the data converting circuit can be made smaller over the LUT from the reason of the approximation calculation, an error is always generated. The multi-bit structure has been advanced in recent years, and the data conversion requires a high precision. Therefore, the error is desired to be decreased as much as possible. In order to decrease the error, there are two methods of a method (1) of increasing the order of an approximation calculation equation and a method (2) of carrying out the calculation by dividing a bit region into a plurality of regions (for example, division into four regions), as shown in FIG. 2.

A data converting circuit with an approximation calculation circuit is described in Japanese Laid Open Patent Application (JP-P2004-212598A, a first conventional example) in which an input digital gradation data is converted into a corrected digital gradation data and then a y correction is carried out. In the approximation calculation circuit in the first conventional example, a sigmoid function is used to represent a non-linear curve in an excellent precision shown in FIG. 1A, only by using only one equation without dividing a calculation section.

Also, a calculator is described in Japanese Laid Open Patent Application (JP-A-Showa, 59-172080, a second conventional example), in which a complex calculation can be carried out at a high speed in a high precision by using a simplified approximation equation. The calculator in the second conventional example contains an approximation calculation circuit for carrying out a calculation by using the simplified approximation equation and determining an approximation value, and an LUT that stores a difference between a true value and the approximation value. The calculator also contains a correction value calculation circuit for determining a correction value through table interpolation; and a circuit for correcting the approximation value by using the correction value.

In order to decrease the calculation error in the approximation calculation circuit, it is adequate to increase the order of the approximation calculation equation. However, as described in the first conventional example, in the calculation using the sigmoid function, the order of the equation is very high, the number of necessary multipliers is increased, and the circuit scale of the approximation calculation circuit becomes extremely large to require a large chip size. As a result, the cost is increased. Also, as the order is increased, the number of the parameters to control the curve is increased, thereby enlarging the scale of the LUT for storing these parameters.

Also, although the calculator in the second conventional example carries out the calculation by using the simplified approximation equation, the difference between the true value and the approximation value needs to be stored in the LUT in units of small sections. Thus, the scale of the LUT is increased, thereby requiring the large chip size.

### SUMMARY OF THE INVENTION

In an aspect of the present invention, a data converting circuit includes an approximation calculation circuit configured to calculate an approximation value of an output to input data by using an n-th order equation (n is an integer equal to or more than one); an error reducing circuit configured to generate an error correction value by using a multiplication factor determined based on the input data; and an addition section configured to add the approximation value and the error correction value and outputs an addition result.

Here, the data converting circuit may further include a look up table (LUT) configured to store data of a plurality of control points and the multiplication factor to a specific region predetermined to the input data. The approximation calculation circuit may refer to the LUT based on the input data to read out the data of the plurality of control points, and calculate the approximation value to the input data by carrying out an approximation calculation using the n-th order equation and the data of the plurality of control points. The error reducing circuit may calculate a basic correction value from an error approximation equation based on the input data and determine the error correction value from the multiplication factor outputted from the LUT and the basic correction value.

Also, the error reducing circuit may hold the error approximation equation which is determined based on predetermined lower bits of the input data.

Also, a plurality of regions may be set and one the plurality of regions may be selected as the specific region based on the input data. The n-th order equation and the error approximation equation may be different for every region.

Also, when the n-th order equation is a secondary equation, and the plurality of control points are three of a start point, a middle point, and an end point, the error approximation equation may be a function which is convex in an upper direction between the start point and the middle point and convex in a lower direction between the middle point and the end point.

Instead, when the n-th order equation is a secondary equation, and the plurality of control points are three of a start point, a middle point, and an end point, the error approximation equation may be a function which is convex in a lower direction between the start point and the middle point and convex in an upper direction between the middle point and the end point.

Also, when the n-th order equation is a primary equation, and the plurality of control points are two of a start point, and an end point, the error approximation equation is a function which is convex in an upper direction between the start point and the end point.

Instead, the n-th order equation is a primary equation, and the plurality of control points are two of a start point, and an end point, the error approximation equation is a function which is convex in a lower direction between the start point and the end point.

In another aspect of the present invention, a data converting circuit includes an approximation calculation circuit configured to calculate an approximation value of an output to input data by using an n-th order equation (n is an integer equal to or more than one) in response to input of the input data; an error reducing circuit configured to generate an error correction value from a preset error approximation equation based on the input data in response to input of the input data; and an addition section configured to add the approximation value and the error correction value and outputs an addition result.

Here, the data converting circuit may further include a look up table (LUT) configured to store data of a plurality of control points and the multiplication factor to a specific region predetermined to the input data. The approximation calculation circuit may refer to the LUT based on the input data to read out the data of the plurality of control points, and calculate the approximation value to the input data by carrying out an approximation calculation using the n-th order equation and the data of the plurality of control points. The error reducing circuit may calculate a basic correction value from the error approximation equation for the specific region based on the input data and determine the error correction value from the multiplication factor outputted from the LUT and the basic correction value.

Also, the error reducing circuit may hold the error approximation equation which is determined based on predetermined lower bits of the input data.

Also, a plurality of regions may be set, one the plurality of regions may be selected as the specific region based on the input data, and the n-th order equation and the error approximation equation may be different for every region.

In still another aspect of the present invention, a data converting circuit which converts an input data showing gradation data of an input digital video data for each of pixels into an output data to output to a display panel, includes an approximation calculation circuit configured to calculate an approximation value to input data by using an n-th order equation (n is an integer equal to or more than one) which approximates an input/output characteristic of the display panel; an error reducing circuit configured to generate an error correction value to the input data; and an adding section configured to add the approximation value from the approximation calculation circuit and the error correction value from the error reducing circuit and to output an addition result.

Here, the data converting circuit may further include a look up table (LUT) configured to store data of a plurality of control points and the multiplication factor for a specific region predetermined to the input data. The approximation calculation circuit may refer to the LUT based on the input gradation data to read out the data of the plurality of control points, and calculate the approximation value to the input gradation data by carrying out an approximation calculation using the n-th order equation and the data of the plurality of control points. The error reducing circuit may calculate a basic correction value from an error approximation equation for the specific region based on the input gradation data and determine the error correction value from the multiplication factor outputted from the LUT and the basis correction value.

Also, when the n-th order equation is a secondary equation, and the plurality of control points are three of a start point, a middle point, and an end point, the error approximation equation may be a function which is convex in an upper direction between the start point and the middle point and convex in a lower direction between the middle point and the end point.

Instead, when the n-th order equation is a secondary equation, and the plurality of control points are three of a start point, a middle point, and an end point, the error approximation equation may be a function which is convex in a lower direction between the start point and the middle point and convex in an upper direction between the middle point and the end point.

Also, when the n-th order equation is a primary equation, and the plurality of control points are two of a start point, and an end point, the error approximation equation is a function which is convex in an upper direction between the start point and the end point.

Instead, the n-th order equation is a primary equation, and the plurality of control points are two of a start point, and an end point, the error approximation equation is a function which is convex in a lower direction between the start point and the end point.

In still another aspect of the present invention, a display apparatus includes a display panel; a holding section configured to hold a gradation data of each of pixels of the digital video data for one line of the display panel; and a data converting circuit. The data converting circuit includes an. approximation calculation circuit configured to calculate an approximation value of an output to input data by using an n-th order equation (n is an integer equal to or more than one); an error reducing circuit configured to generate an error correction value by using a multiplication factor determined based on the input data; and an addition section configured to add the approximation value and the error correction value and outputs an addition result. The n-th order equation expresses γ correction, the data converting circuit outputs the output data by carrying out the γ correction to the input data, and the display panel is driven based on the output data.

Also, the data converting circuit may further include a look up table (LUT) configured to store data of a plurality of control points and the multiplication factor to a specific region predetermined to the input data. The approximation calculation circuit may refer to the LUT based on the input data to read out the data of the plurality of control points, and calculate the approximation value to the input data by carrying out an approximation calculation using the n-th order equation and the data of the plurality of control points. The error reducing circuit may calculate a basic correction value from an error approximation equation based on the input data and determine the error correction value from the multiplication factor outputted from the LUT and the basic correction value.

In the present invention, the error reducing circuit is provided to generate the error correction value to cancel the calculation error, and the error correction value is added to the calculation result of the approximation calculation circuit. Thus, even if the approximation calculation equation whose order is low is used, the conversion error can be decreased. For this reason, the data conversion in the high precision can be attained without any enlargement of the circuit scale.

### BRIEF DESCRIPTION OF THE DRAWINGS

FIG. 1A is a curve showing a relation between an input digital video data and a corrected digital video data after a conversion when a linear DAC is used to drive a data line;

FIG. 1B is a conversion characteristic in the linear DAC;

FIG. 1C is a characteristic curve showing a drive voltage—brightness characteristic in a liquid crystal panel;

FIG. 2 is an example when a calculation is carried out after a division into a plurality of regions;

FIG. 3 is a diagram showing control points when a quadratic approximation calculation is carried out through four divisions;

FIGS. 4A and 4B are diagrams showing the control points of a curve when a quadratic equation is used in an approximation calculation;

FIG. 5 is a view showing a relation between an approximation error and the input digital video data when the quadratic equation is used in the approximation calculation;

FIG. 6 is a block diagram showing the configuration of a data converting circuit according to a first embodiment of the present invention;

FIG. 7 is a diagram showing a relation between a basic correction value and the input digital video data in the first embodiment;

FIG. 8 is a diagram showing a relation between an error correction value and the input digital video data in the first embodiment;

FIGS. 9A to 9C are diagrams showing approximation calculation, an calculation error and the error correction value in a curve of the input digital video data when the curve is sharp in the first embodiment;

FIGS. 10A to 10C are diagrams showing approximation calculation, an calculation error and the error correction value in a curve of the input digital video data when the curve is gentle in the first embodiment;

FIG. 11 is a diagram showing a mechanism for error reduction in the first embodiment of the data converting circuit in the present invention;

FIG. 12 is a diagram showing control points when a four-division and a linear equation approximation calculation are carried out;

FIGS. 13A and 13B are diagrams showing the control points of the curve when the linear equation is used for the approximation calculation;

FIG. 14 is a diagram showing a relation between a calculation error and an input digital video data when the linear equation is used for the approximation calculation;

FIG. 15 is a block diagram showing the configuration of the data converting circuit according to a second embodiment of the present invention;

FIG. 16 is a diagram showing a relation between a basic correction value and the input digital video data in the second embodiment;

FIG. 17 is a diagram showing a relation between an error correction value and the input digital video data in the second embodiment;

FIGS. 18A to 18C are diagrams showing approximation calculation, an calculation error, and an error correction value in a curve of the input digital video data when the curve is sharp in the second embodiment;

FIGS. 19A to 19C are diagrams showing approximation calculation, an calculation error, and an error correction value in a curve of the input digital video data when the curve is gentle in the second embodiment;

FIGS. 20A and 20B are diagrams showing control points of the curve when a start point P1 and an end point 2 are slightly shifted from a true value, when the linear equation is used for the approximation calculation;

FIG. 21 is a diagram showing a relation between the approximation error and the input digital video data, when the start point P1 and the end point 2 are slightly shifted from the true value; and

FIG. 22 is a diagram showing a relation between the basic correction value and the input digital video data when the start point P1 and the end point P2 are slightly shifted from the true value, in the second embodiment.

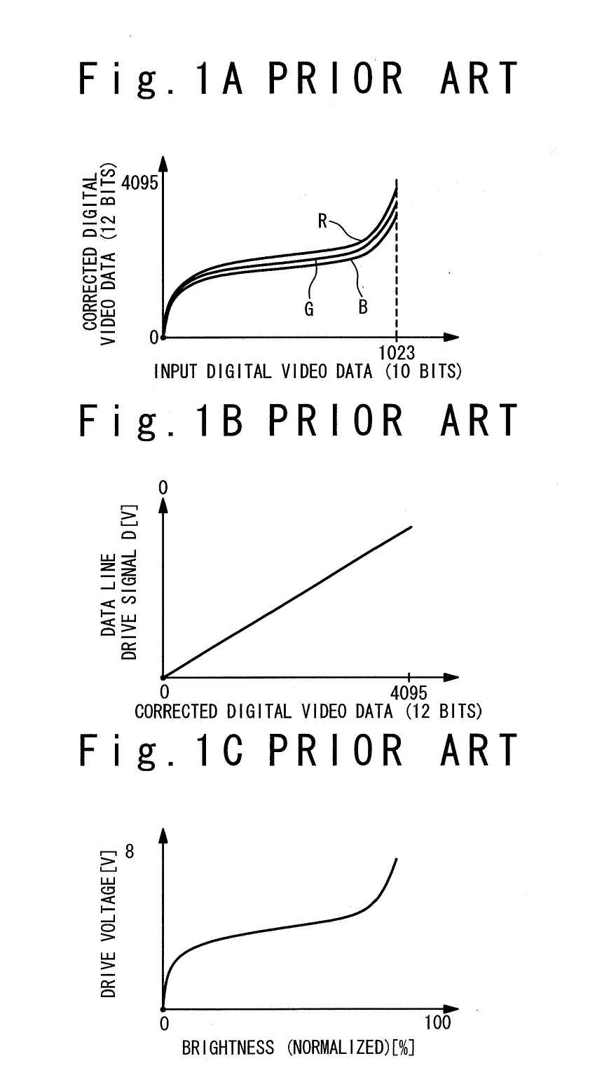

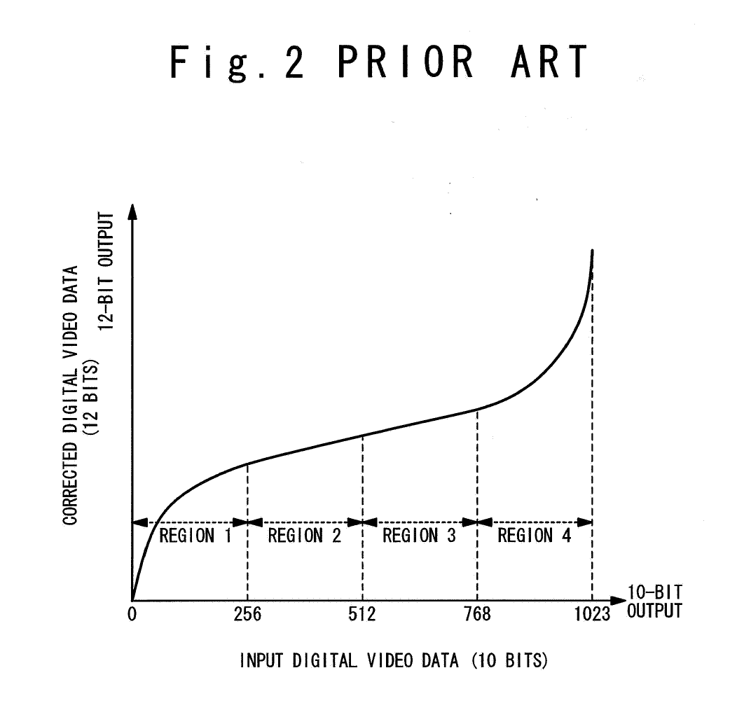

### DESCRIPTION OF THE PREFERRED EMBODIMENTS

Hereinafter, a display apparatus using a data converting circuit according to the present invention will be described in detail with reference to the attached drawings.

### First Embodiment

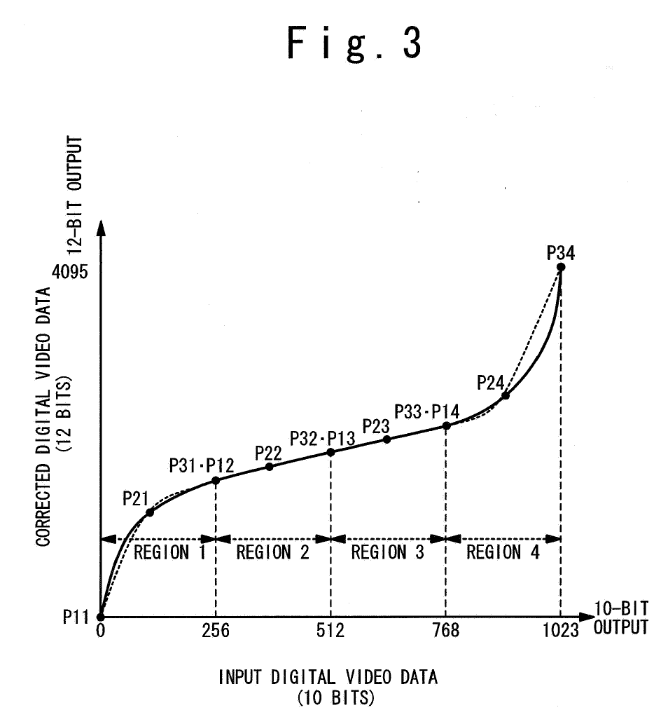

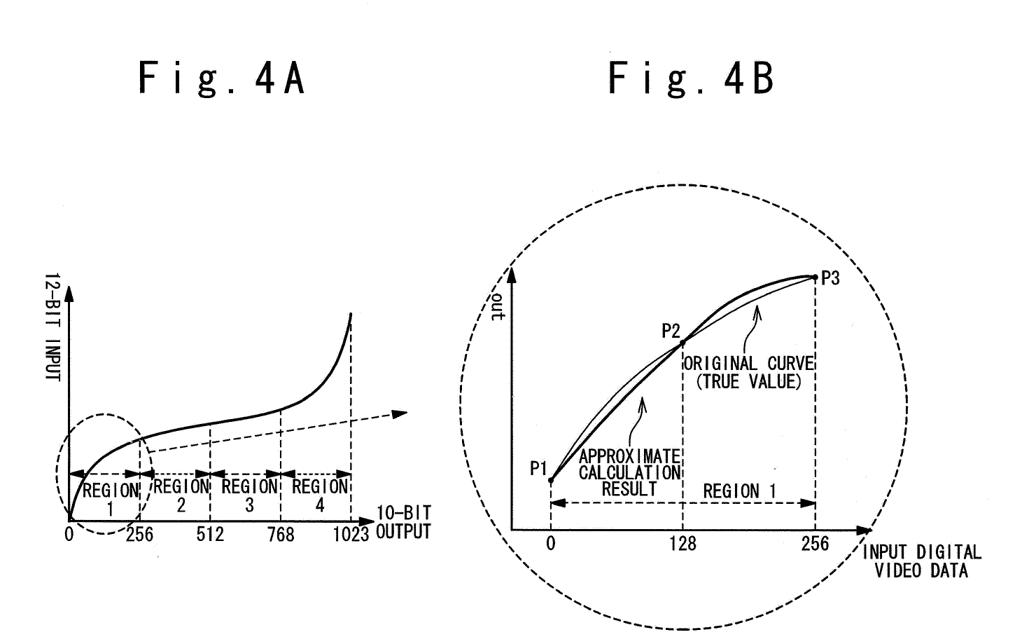

In the data converting circuit according to the first embodiment of the present invention, as shown in FIG. 3, a 4-divisional approximation calculation is carried out by using a quadratic curve. A pixel data of an input digital video data has 10 bits, and the pixel data of a corrected digital video data after a conversion has 12 bits. Typically, when the approximation calculation is carried out by using an n-th order equation (n is an integer of 1 or more), (n+1) control points need to be set on the curve. Thus, in case of the quadratic curve, 3 control points need to be set on the curve for each region. The 3 control points are typically a start point P1, a curve pass point P2 at the center of the calculation region, and an end point P3. As shown in FIGS. 4A and 4B, since the control points P1, P2 and P3 are set to true values (respectively, of 12 bits), the original curve can be approximately represented. However, because of the approximation calculation, a calculation error from the original curve is always generated. When the quadratic equation is used in the calculation, a relation between this calculation error and the input digital video data is always as shown in FIG. 5. Although the calculation error is 0 at the points P1, P2 and P3, the calculation error becomes maximum in a negative direction near the middle point between the point P1 and the point P2 and in a positive direction near the middle point between the point P2 and the point P3. Also, as described above, there is a feature that the polarity of the calculation error is inverted with the point P2 as a boundary. In the present invention, this feature is used to try the reduction in the error.

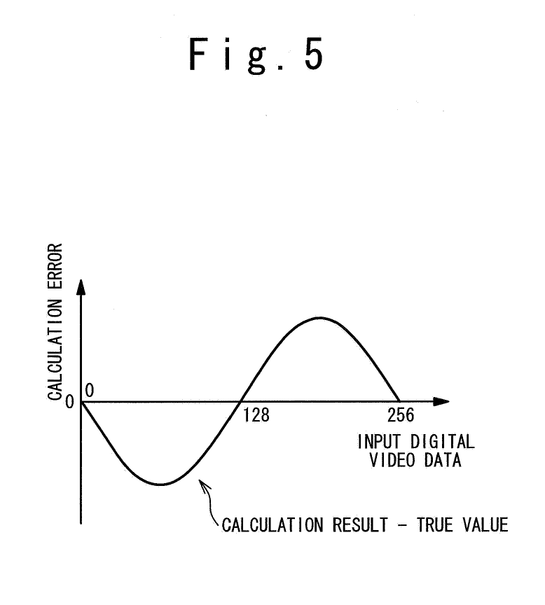

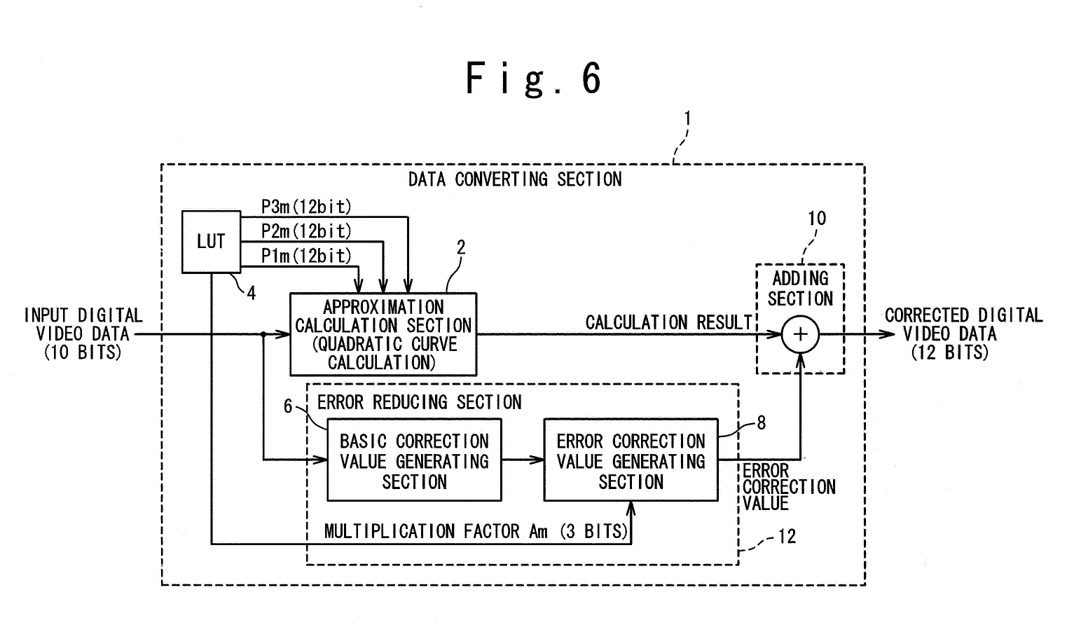

FIG. 6 is a block diagram showing the configuration of the data converting circuit 1 according to the first embodiment of the present invention. With reference to FIG. 6, the data converting circuit 1 in the first embodiment contains an approximation calculation section 2, an LUT (Look Up Table) 4, an error reducing section 12 and an adding section 10. The error reducing section 12 contains a basic correction value generating section 6 and an error correction value generating section 8. In the first embodiment, a 10-bit region of each pixel data of the input digital video data is divided into the four regions of a region 1, a region 2, a region 3 and a region 4, as shown in FIG. 3.

The LUT 4 stores the 12-bit data indicating control points P1m, P2m, and P3m (m=1 to 4) in each of the four regions and a 3-bit data Am (m=1 to 4) indicating a multiplication factor to the correction value in the corresponding region.

When receiving a 10-bit gradation data of each pixel of the input digital video data, the approximation calculation section 2 refers to the LUT 4 and reads the data of the control points P1m, P2m and P3m in the calculation region corresponding to the gradation data among the 4 regions. At this time, the LUT 4 simultaneously outputs a multiplication factor Am corresponding to the calculation region. After that, the approximation calculation section 2 uses the quadratic curve equation and performs the approximation calculation in the calculation region on the pixel data.

The basic correction value generating section 6 of the error reducing section 12 has a correction value function of a triangle wave or stepped wave. When the gradation data of each pixel of the input digital video data is supplied, the basic correction value corresponding to the gradation data is outputted from the correction value function.

The error correction value generating section 8 of the error reducing section 12 multiplies the basic correction value by the multiplication factor Am outputted from the LUT 4 and outputs the multiplication result as an error correction value.

The adding section 10 adds the calculation result outputted from the approximation calculation section 2 and the error correction value outputted from the error reducing section 12. In this way, the gradation data of each pixel of the corrected digital video data is obtained which corresponds to the gradation data of each pixel of the input digital video data.

The operation of the data converting circuit according to the first embodiment of the present invention will be described below with reference to FIG. 11.

When receiving the digital video data, the approximation calculation section 2 reads the control points P1m, P2m and P3m in the calculation region corresponding to the gradation data of each pixel of the input digital video data from the LUT 4 and defines the gradation data of the input digital video data as a variable and then carries out the approximation calculation of the quadratic equation. For example, when the gradation data of the input digital video data is [100], as shown in FIG. 3, the control points P11, P21 and P31 in a calculation region 1 (0 to 255) are used to carry out the approximation calculation. Also, when the input digital video data is [700], the control points P13, P23, and P33 in the calculation region 3 (512 to 767) and the quadratic equation are used to carry out the approximation calculation. At this time, a calculation error is generated between the calculation result and the true value. A relation between the input digital video data and the calculation error is always as shown in FIG. 5.

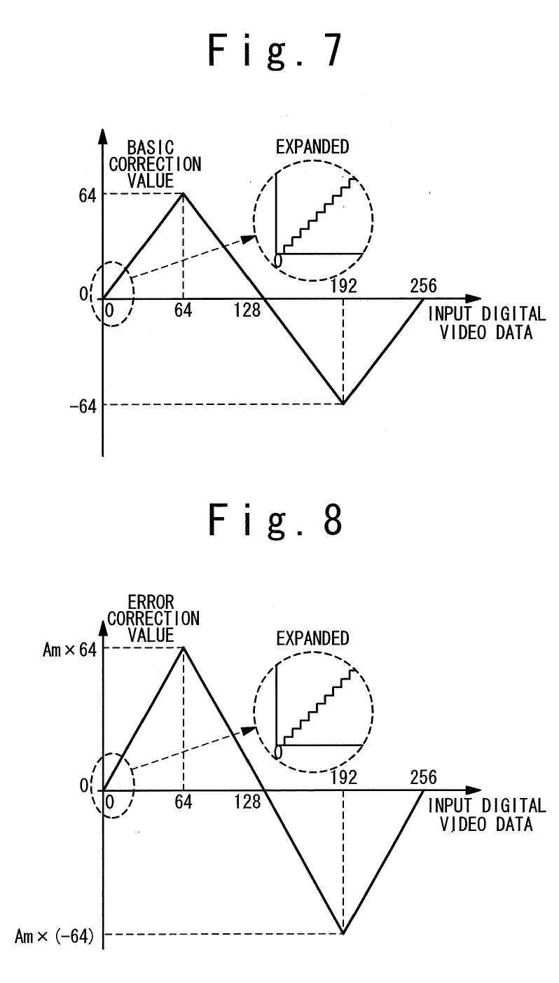

At first, the basic correction value generating section 6 of the error reducing section 12 holds the correction value function of the triangle wave or stepped wave shown in FIG. 7. In this example, the basic correction function value is increased by [1], step by step, and arrives at [64], when the lower bits of the gradation data of the input digital video data show a value between [0] and [64]. The basic correction function value is decreased by [1], step by step, and arrives at [−64], when the lower bits show a value between [65] and [192]. The basic correction function value is increased by [1], step by step, and arrives at [0], when the lower bits show a value between [193] and [256]. In this way, the basic correction value generating section 6 of the error reducing section 12 generates the basic correction value from the correction value function shown in FIG. 7, in accordance with the lower 8 bits of the input digital video data. The error correction value generating section 8 of the error reducing section 12 receives the multiplication factor Am corresponding to the calculation region from the LUT 4 and multiplies the basic correction value by Am, as shown in FIG. 8, and generates the error correction value.

In FIG. 7, the correction value function is convex in the positive direction between the points P1 and P2 and in the negative direction between the points P2 and P3. However, the correction value function is convex in the negative direction between the points P1 and P2 and in the positive direction between the points P2 and P3, although being not shown.

The error reducing section 12 generates the error correction value so as to cancel the calculation error caused by the calculation result from the approximation calculation section 2. In the present invention, the approximation calculation of a wide region is carried out by the approximation calculation section 2, and the error reducing calculation of the approximation calculation is carried out by the error reducing section 12. Since the error is typically smaller than the result of the approximation calculation, the lower bits of the input gradation data are used to obtain the error correction value. In this way, since the whole of the input gradation data is not used, the circuit scale can be made small.

The adding section 10 adds the calculation result outputted from the approximation calculation section 2 and the error correction value outputted from the error reducing section 12. In this way, the gradation data of each pixel of the corrected digital video data can be obtained.

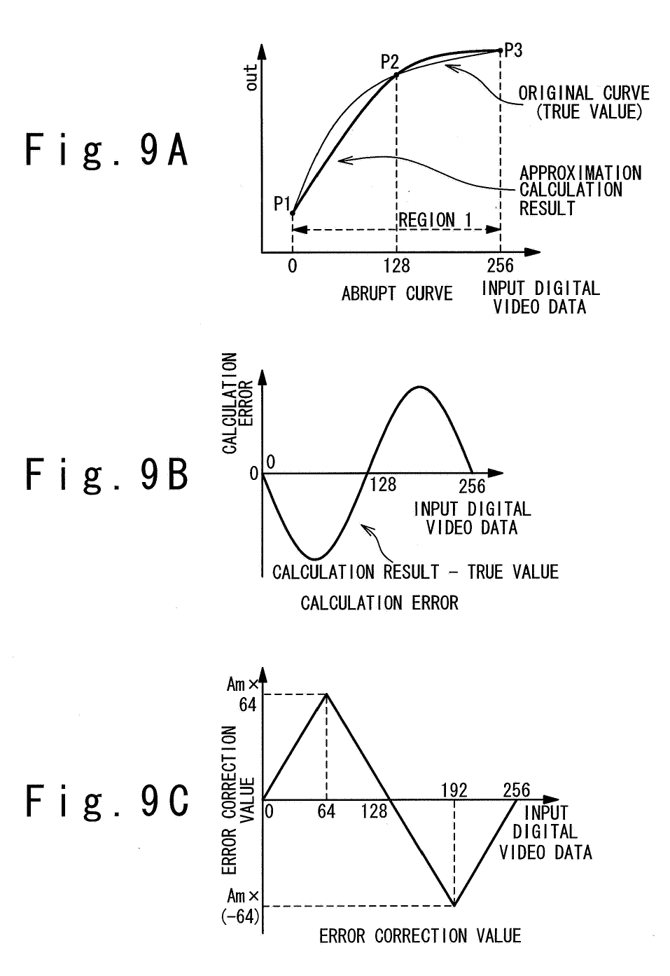

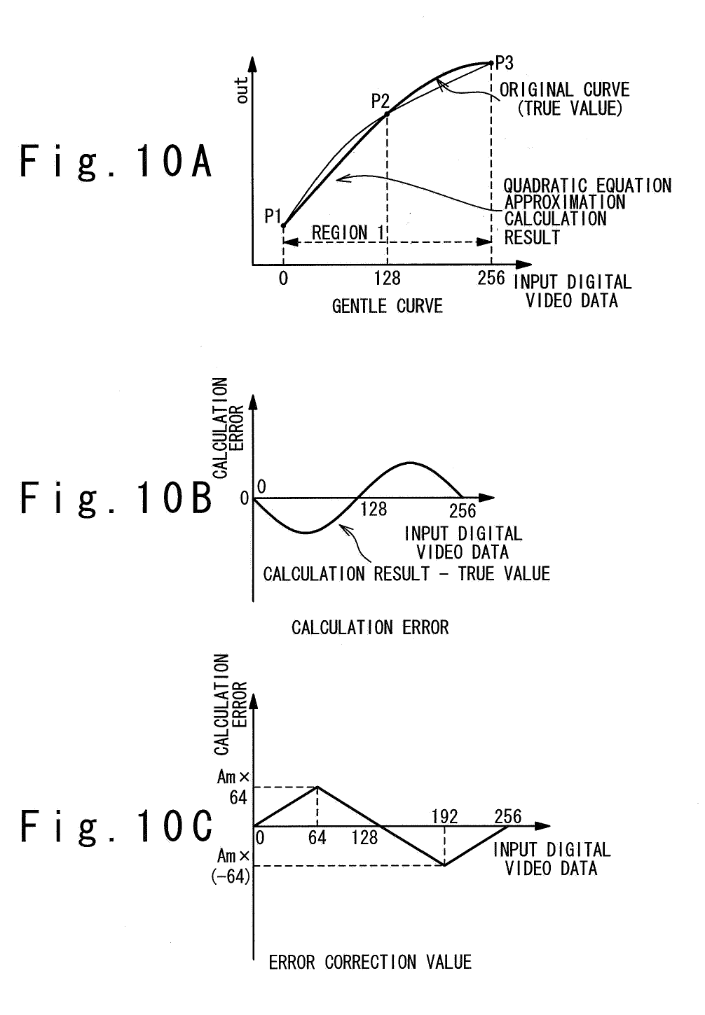

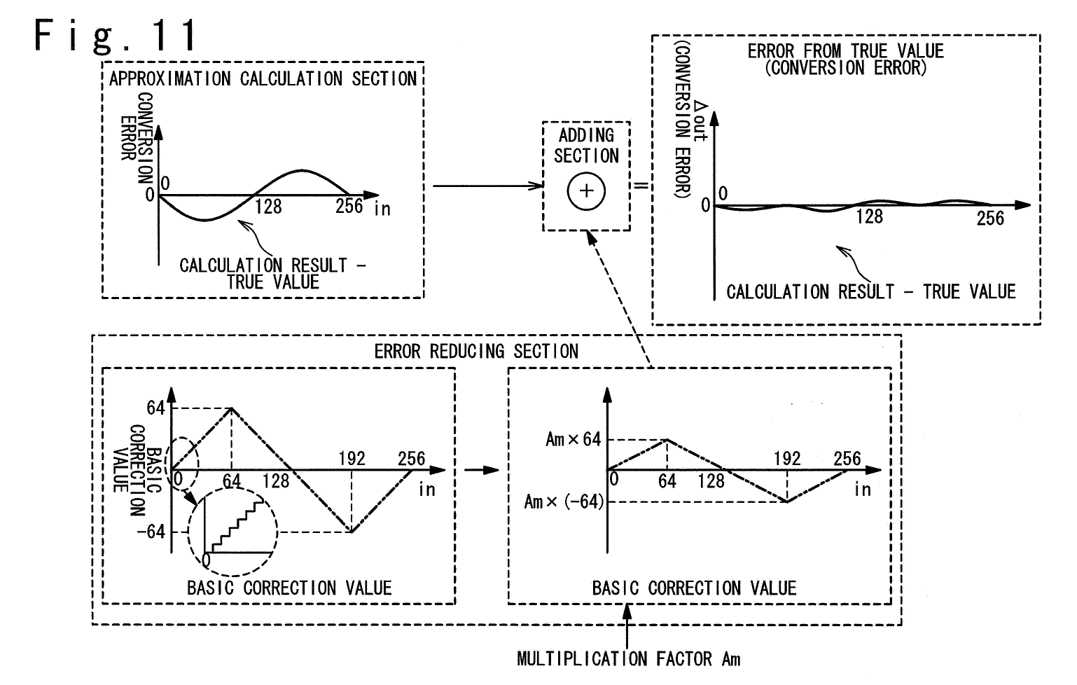

As described above, in the present invention, the magnitude of the error correction value is specified by the multiplication factor A. For example, as shown in FIGS. 9A to 9C, when the curve is sharp and the calculation error is large, the multiplication factor Am is set to a great value. Conversely, as shown in FIGS. 10A to 10C, when the curve is gentle and the calculation error is small, the multiplication factor Am is set to a low value.

In the present invention, the error reducing section 12 for generating the error correction value is installed to cancel the calculation error, and the error correction value is added to the calculation result of the approximation calculation section 2. Thus, even if the approximation calculation equation whose order is low is used, the calculation error can be decreased. In short, the data conversion in a high precision can be attained without enlarging the circuit scale of the approximation calculation section 2. Also, the basic correction value generating section 6 of the error reducing section 12 can easily generate the basic correction value from the lower bits (in this example, 8 bits) of the input digital video data. Thus, the basic correction value can be attained under the extremely small circuit scale.

Moreover, even with regard to the error correction value generating section 8 of the error reducing section 12, when the multiplication factor Am is assumed to have only the power of 2 (for example, in case of 3 bits, 8 kinds of 4 times, 2 times, 1 time, 0, 5 times, 0, 2.5 times, 0.125 times, 0.0625 times and 0), the error correction value can be generated only by performing a bit shift on the basic correction value. Thus, the error correction value can be attained under the extremely small circuit scale. Moreover, the number of the parameters (multiplication factor Am) which are stored in the LUT 4 and are used to reduce the error may be only one per region, and about 3 bits are adequate. Thus, the LUT 4 needs not to be enlarged.

As can be understood from the foregoing description, the present invention can attain the data converting circuit in the high precision without enlarging the circuit scale. By the way, in this embodiment, the case of using the quadratic equation to carry out the approximation calculation has been exemplified. However, a cubic and the like may be used in the approximation equation. Also, in this embodiment, the region is divided into four components. However, the number of the division regions may be arbitrary, or the region may not be divided.

### Second Embodiment

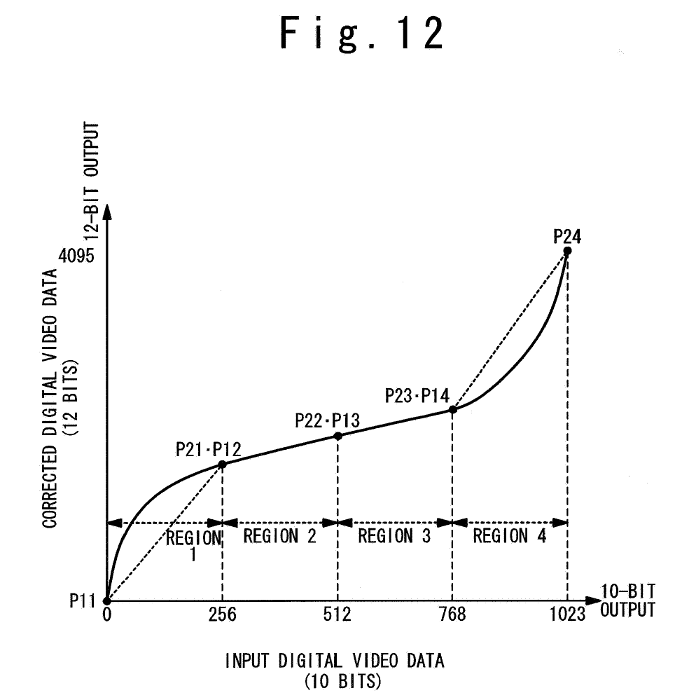

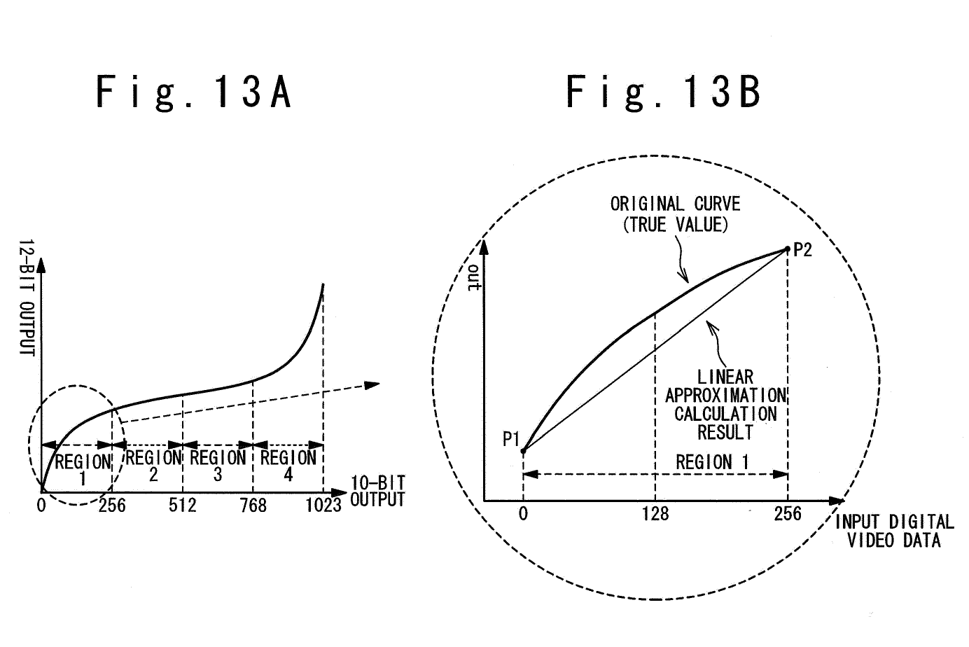

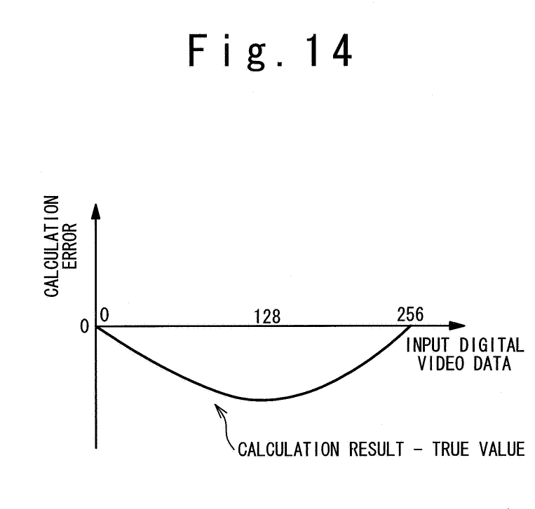

The data converting circuit according to the second embodiment of the present invention will be described below. In the second embodiment of the present invention, as shown in FIG. 12, similarly to the first embodiment, the region is divided into the 4 regions. However, the second embodiment is different from the first embodiment in that the linear equation (approximation to a straight line) is used. In case approximation to the straight line, the two control points on the curve need for each region. As these two control points, there are the start point 1 and the end point 2, as shown in FIGS. 13A and 13B. Since the control points P1 and P2 are set to the true values (respectively, 12 bits), the original curve becomes approximate to the straight line. In the case approximate to the straight line, a relation between the error and the input digital video data is always as shown in FIG. 14. This case is characterized in that on the points P1 and P2, the calculation error is 0 and the calculation error becomes maximal in a negative direction near the middle point between the points P1 and P2. Similarly to the first embodiment, this feature is used to be able to reduce the error.

FIG. 15 is a block diagram showing the configuration of the data converting circuit according to the second embodiment of the present invention. The data converting circuit in the second embodiment is similar to the first embodiment. With reference to FIG. 15, the data converting circuit in the second embodiment contains an approximation calculation section 22, an LUT (Look Up Table) 24, an error reducing section 32 and an adding section 30. The error reducing section 32 contains a basic correction value generating section 26 and an error correction value generating section 28. In the second embodiment, a 10-bit region of each pixel data of the input digital video data is divided into the four regions of a region 1, a region 2, a region 3 and a region 4, as shown in FIG. 12.

The LUT 24 stores the 12-bit data indicating the control points P1m and P2m (m=1 to 4) in each of the four regions and the 3-bit data Am (m=1 to 4) indicating the multiplication factor to the correction value in the corresponding region.

When receiving the 10-bit gradation data of each pixel of the input digital video data, the approximation calculation section 22 refers to the LUT 24 and reads the data of the control points P1m and P2m in the calculation region corresponding to the gradation data among the 4 regions. At this time, the LUT 24 simultaneously outputs the multiplication factor Am corresponding to the calculation region. After that, the approximation calculation section 22 uses the linear equation and performs the approximation calculation in the calculation region on the pixel data.

The basic correction value generating section 26 of the error reducing section 32 has the correction value function of the triangle wave or stepped wave. When the gradation data of each pixel of the input digital video data is supplied, the basic correction value corresponding to the gradation data from the correction value function is outputted.

The error correction value generating section 28 of the error reducing section 32 multiplies the basic correction value by the multiplication factor Am outputted by the LUT 24 and outputs as the error correction value.

The adding section 30 adds the calculation result outputted from the approximation calculation section 22 and the error correction value outputted from the error reducing section 32. In this way, the gradation data of the pixel of the corrected digital video data is obtained which corresponds to the gradation data of each pixel of the input digital video data.

When receiving the pixel data of the digital video data, the approximation calculation section 22 reads the data of control points P1n and P2n in the calculation region corresponding to the input digital video data from the LUT 24 and defines the input digital video data as a variable and then carries out the approximation calculation by using the linear expression. For example, when the input digital video data is [100], the control points P11 and P21 in the calculation region 1 (0 to 255) are used to carry out the approximation calculation (refer to FIG. 12). Also, when the input digital video data is [700], the data of the control points P13 and P23 in the calculation region 3 (512 to 767) are used to carry out the approximation calculation (refer to FIG. 12). At that time, the calculation error is generated between the calculation result and the true value. A relation between the input digital video data and the calculation error is always as shown in FIG. 14.

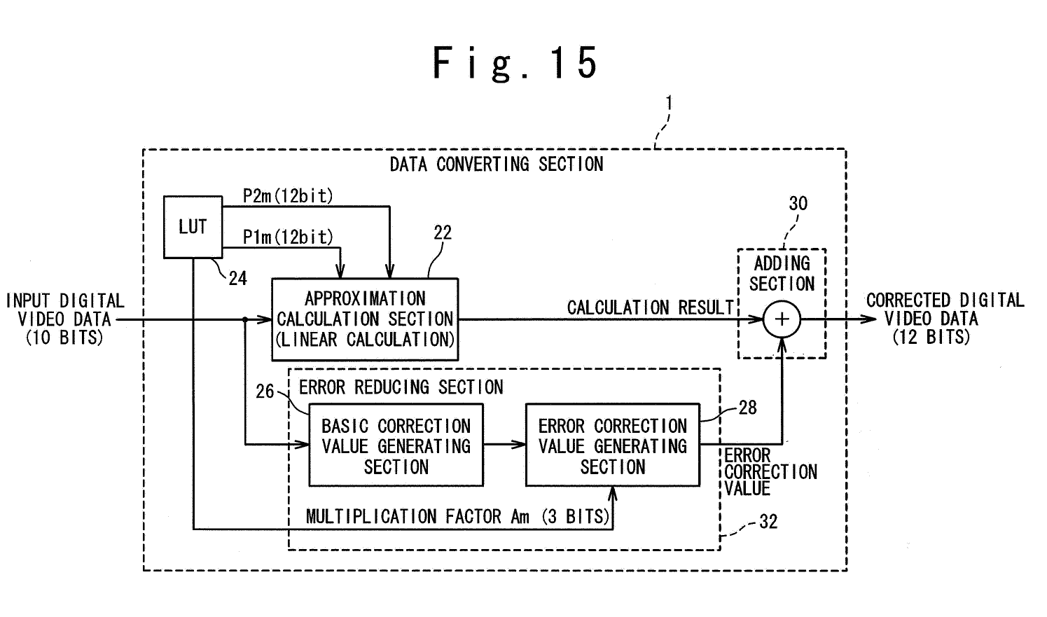

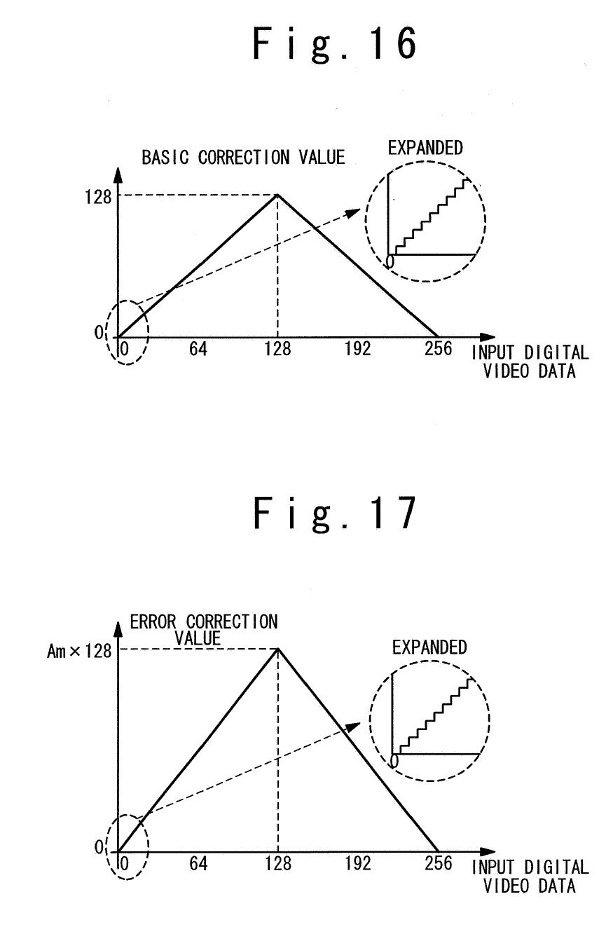

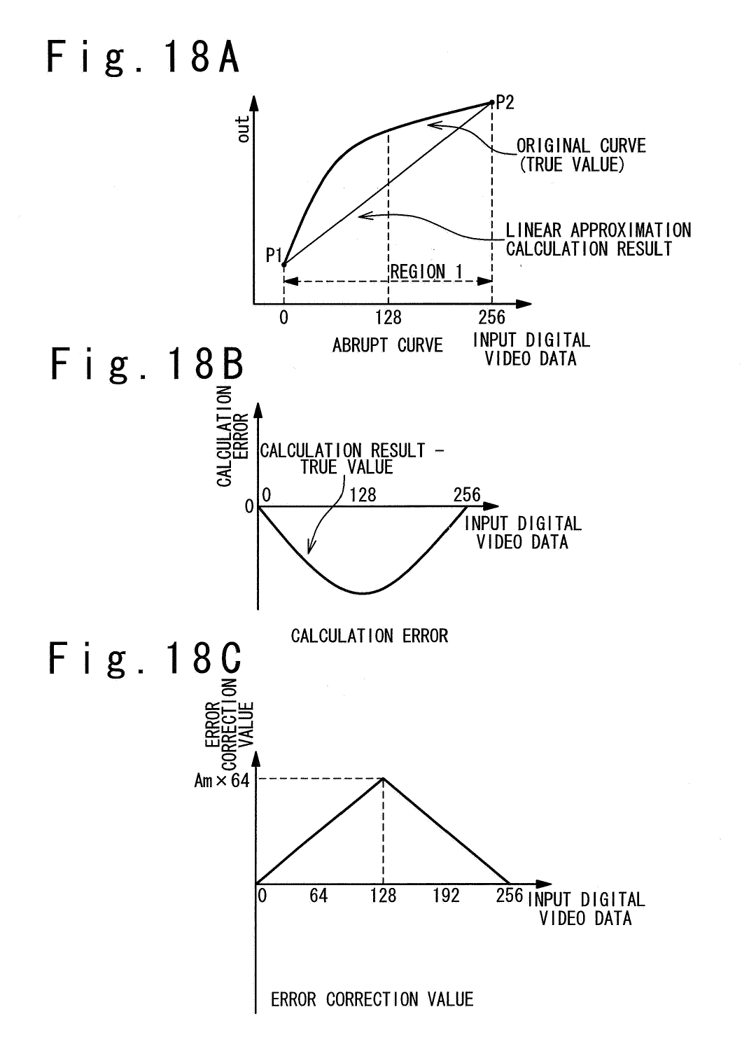

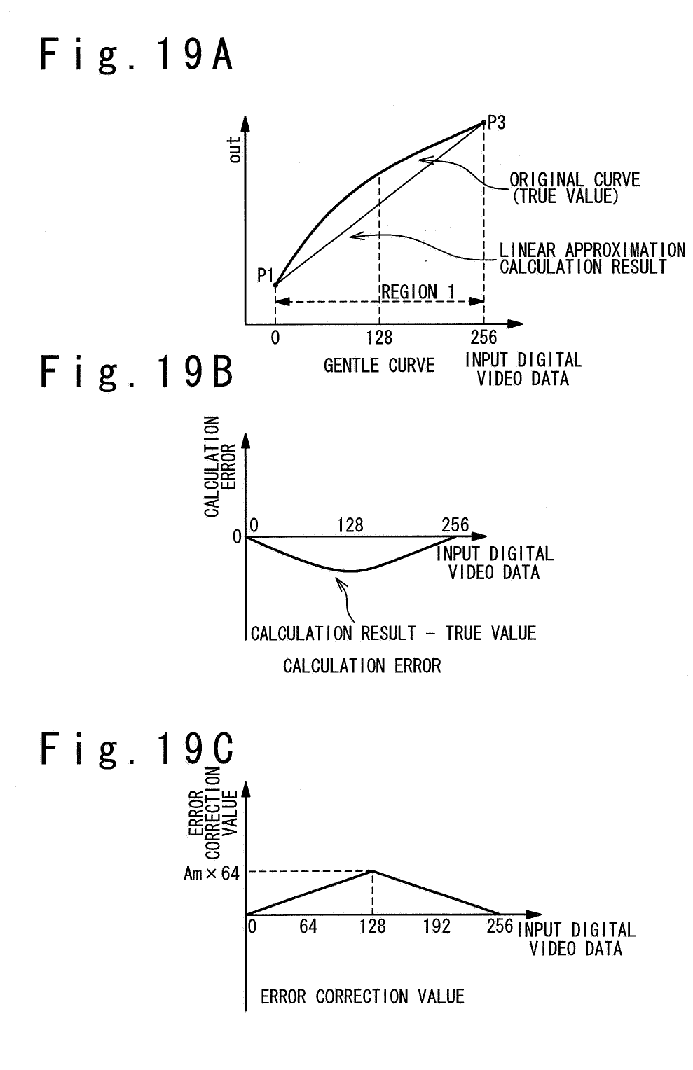

The error reducing section generates the error correction value so as to cancel the calculation error. At first, the error reducing section 32 uses the lower bits of the input digital video data and generates the basic correction value from the correction value function shown in FIG. 16. Next, the error reducing section 32 reads the multiplication factor Am (3 bits) corresponding to the calculation region stored in the LUT 24, multiplies the basic correction value by the multiplication factor Am and generates the error correction value shown in FIG. 17. In this way, the magnitude of the error correction value is specified in accordance with the multiplication factor Am. For example, as shown in FIGS. 18A to 18C, when the region is sharp and the calculation error is great, the multiplication factor due to the Am may be set to the great value. Conversely, as shown in FIGS. 19A to 19C, when the region is gentle and the calculation error is small, the multiplication factor Am may be set to the low value.

In FIG. 16, the correction value function is convex in the positive direction between the points P1 and P2. However, the correction value function is convex in the negative direction between the points P1 and P2, although being not shown.

The adding section adds the calculation result outputted from the approximation calculation section and the error correction value outputted as described in the error reducing section and generates the pixel data of the corrected digital video data.

The second embodiment uses the approximation calculation section 22 to carry out the calculation using the straight line equation (the linear equation). Thus, the necessary number of the multipliers can be reduced, and the circuit scale of the calculation circuit or section can be reduced over the first embodiment. Moreover, because of the calculation using the straight line equation, the number of the control points to be stored in the LUT 24 can be reduced over the first embodiment, and the circuit scale of the LUT can be also made small. From the foregoing description, it is possible to attain the data converting circuit whose circuit scale is smaller than that of the first embodiment.

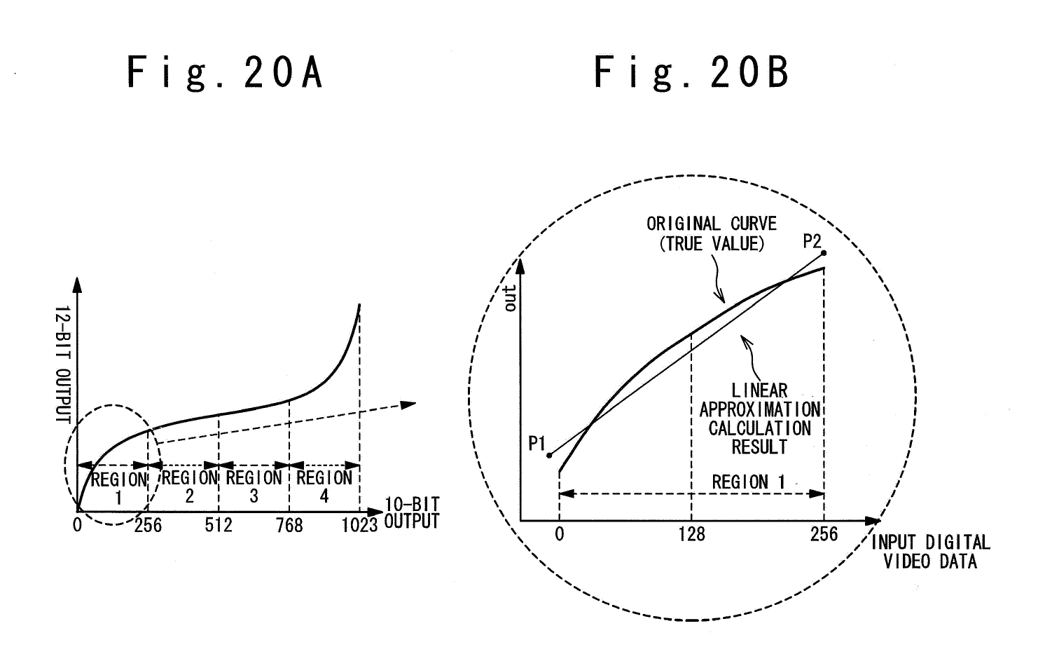

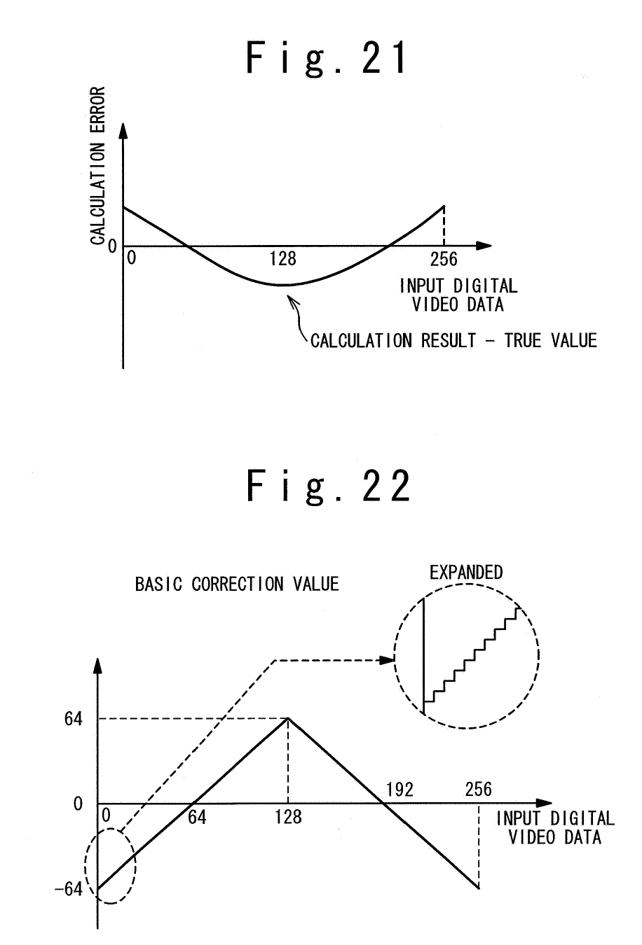

Also, in the above embodiments, a case that the approximation calculation is carried out by using the four-divisional regions has been described. However, the number of the divisional regions may be optional, or the division may not be executed. Moreover, the case that the start point P1 and the end point P2 are set at the true values has been described. However, as shown in FIGS. 20A and 20B, the points P1 and P2 may be slightly shifted from the true values, and the absolute value of the error may be made small. In that case, a relation between the error and the input digital video data is as shown in FIG. 21. Thus, the error reducing section may generate the basic correction value as shown in FIG. 22.

In the present invention, the data converting circuit in the high precision can be attained without enlarging the circuit scale.

The data converting circuit of the present invention can be applied to a display apparatus. For example, the digital video data sent from an external device to the display apparatus is stored in a memory (not shown) and read out from the memory for each line of a displaying panel. The read digital video data is sent for each pixel to the data converting circuit of the present invention, and the pixel data (gradation data) of the corrected digital video data is generated. A display panel (not shown) of the display apparatus is driven based on the pixel data (gradation data) of the corrected digital video data. In this way, the video data is displayed on one line of the display panel. Since each line on the display panel is scanned, the video data for one screen is displayed.

What is claimed is:

1. A data converting circuit comprising:
an approximation calculation circuit configured to calculate an approximation value of an output to input data by using an n-th order equation (n is an integer equal to or more than one);
an error reducing circuit configured to generate an error correction value by using a multiplication factor determined based on said input data; and
an addition section configured to add said approximation value and said error correction value and outputs an addition result.

2. The data converting circuit according to claim 1, further comprising:
a look up table (LUT) configured to store data of a plurality of control points and said multiplication factor to a specific region predetermined to said input data,
wherein said approximation calculation circuit refers to said LUT based on said input data to read out the data of said plurality of control points, and calculates said approximation value to said input data by carrying out an approximation calculation using said n-th order equation and the data of said plurality of control points, and
said error reducing circuit calculates a basic correction value from an error approximation equation based on said input data and determines said error correction value from said multiplication factor outputted from said LUT and said basic correction value.

3. The data converting circuit according to claim 2, wherein said error reducing circuit holds said error approximation equation which is determined based on predetermined lower bits of said input data.

4. The data converting circuit according to claim 2, wherein a plurality of regions are set and one of said plurality of regions is selected as said specific region based on said input data, and
said n-th order equation and said error approximation equation are different for every region.

5. The data converting circuit according to claim 2, wherein said n-th order equation is a secondary equation,
said plurality of control points are three of a start point, a middle point, and an end point, and
said error approximation equation is a function which is convex in an upper direction between said start point and said middle point and convex in a lower direction between said middle point and said end point.

6. The data converting circuit according to claim 2, wherein said n-th order equation is a secondary equation,
said plurality of control points are three of a start point, a middle point, and an end point, and
said error approximation equation is a function which is convex in a lower direction between said start point and said middle point and convex in an upper direction between said middle point and said end point.

7. The data converting circuit according to claim 2, wherein said n-th order equation is a primary equation,
said plurality of control points are two of a start point, and an end point, and
said error approximation equation is a function which is convex in an upper direction between said start point and said end point.

8. The data converting circuit according to claim 2, wherein said n-th order equation is a primary equation,
said plurality of control points are two of a start point, and an end point, and
said error approximation equation is a function which is convex in a lower direction between said start point and said end point.

9. A data converting circuit comprising:
an approximation calculation circuit configured to calculate an approximation value of an output to input data by using an n-th order equation (n is an integer equal to or more than one) in response to input of said input data;
an error reducing circuit configured to generate an error correction value from a preset error approximation equation based on said input data in response to input of said input data; and
an addition section configured to add said approximation value and said error correction value and outputs an addition result.

10. The data converting circuit according to claim 9, further comprising:
a look up table (LUT) configured to store data of a plurality of control points and said multiplication factor to a specific region predetermined to said input data,
wherein said approximation calculation circuit refers to said LUT based on said input data to read out the data of said plurality of control points, and calculates said approximation value to said input data by carrying out an approximation calculation using said n-th order equation and the data of said plurality of control points, and
said error reducing circuit calculates a basic correction value from said error approximation equation for said specific region based on said input data and determines said error correction value from said multiplication factor outputted from said LUT and said basic correction value.

11. The data converting circuit according to claim 10, wherein said error reducing circuit holds said error approximation equation which is determined based on predetermined lower bits of said input data.

12. The data converting circuit according to claim 10, wherein a plurality of regions are set,
one of said plurality of regions is selected as said specific region based on said input data, and
said n-th order equation and said error approximation equation are different for every region.

13. A data converting circuit which converts an input data showing gradation data of an input digital video data for each of pixels into an output data to output to a display panel, comprising:
an approximation calculation circuit configured to calculate an approximation value to input data by using an n-th order equation (n is an integer equal to or more than one) which approximates an input/output characteristic of said display panel;
an error reducing circuit configured to generate an error correction value to said input data; and
an adding section configured to add said approximation value from said approximation calculation circuit and said error correction value from said error reducing circuit and to output an addition result.

14. The data converting circuit according to claim 13, further comprising:
a look up table (LUT) configured to store data of a plurality of control points and said multiplication factor for a specific region predetermined to said input data,
wherein said approximation calculation circuit refers to said LUT based on said input gradation data to read out the data of said plurality of control points, and calculates said approximation value to said input gradation data by carrying out an approximation calculation using said n-th order equation and the data of said plurality of control points, and
said error reducing circuit calculates a basic correction value from an error approximation equation for said specific region based on said input gradation data and determines said error correction value from said multiplication factor outputted from said LUT and said basis correction value.

15. The data converting circuit according to claim 14, wherein said n-th order equation is a secondary equation,
said plurality of control points are three of a start point, a middle point, and an end point, and
said error approximation equation is a function which is convex in an upper direction between said start point and said middle point and convex in a lower direction between said middle point and said end point.

16. The data converting circuit according to claim 14, wherein said n-th order equation is a secondary equation,
said plurality of control points are three of a start point, a middle point, and an end point, and
said error approximation equation is a function which is convex in a lower direction between said start point and said middle point and convex in an upper direction between said middle point and said end point.

17. The data converting circuit according to claim 14, wherein said n-th order equation is a primary equation,
said plurality of control points are two of a start point, and an end point, and
said error approximation equation is a function which is convex in an upper direction between said start point and said end point.

18. The data converting circuit according to claim 14, wherein said n-th order equation is a primary equation,
said plurality of control points are two of a start point, and an end point, and
said error approximation equation is a function which is convex in a lower direction between said start point and said end point.

19. A display apparatus comprising:
a display panel;
a holding section configured to hold a gradation data of each of pixels of said digital video data for one line of said display panel; and
a data converting circuit,
wherein said data converting circuit comprises:
an approximation calculation circuit configured to calculate an approximation value of an output to input data by using-an n-th order equation (n is an integer equal to or more than one);
an error reducing circuit configured to generate an error correction value by using a multiplication factor determined based on said input data; and
an addition section configured to add said approximation value and said error correction value and outputs an addition result,
said n-th order equation expresses γ correction,
said data converting circuit outputs said output data by carrying out said γ correction to said input data, and
said display panel is driven based on said output data.

20. The display apparatus according to claim 19, wherein said data converting circuit further comprises:
a look up table (LUT) configured to store data of a plurality of control points and said multiplication factor to a specific region predetermined to said input data,
wherein said approximation calculation circuit refers to said LUT based on said input data to read out the data of said plurality of control points, and calculates said approximation value to said input data by carrying out an approximation calculation using said n-th order equation and the data of said plurality of control points, and
said error reducing circuit calculates a basic correction value from an error approximation equation based on said input data and determines said error correction value from said multiplication factor outputted from said LUT and said basic correction value.
